(19) United States
(12) Patent Application Publication
(10) Pub. No.: US 2009/0038214 A1
(43) Pub. Date: Feb. 12, 2009

(54) Golf course bunker boundary protection system

(75) Inventor: Wayne A. Rozen, Binghamton, NY (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Indian Valley Industries, Inc.

(21) Appl. No.: 11/889,348

(22) Filed: Aug. 10, 2007

(51) Int. Cl. A01G 1/08

(52) U.S. Cl. 47/33; 405/302.7; 47/58.1 R; 52/102

(57) ABSTRACT

The golf course bunker boundary protection system includes a central section located adjacent to the wall of a bunker, a plurality of lower anchors coupled to the central section and located below the sand in the bunker and above the soil in the bunker below the sand, and a plurality of upper anchors coupled to the central section and located between the grass surrounding the bunker and the soil. The upper anchors include a means for attaching the upper anchors to the grass, and the lower anchors include a means for securing the lower anchors to the soil, such as staples, pins, or nails. Advantageously, the upper and lower anchors and the central section are formed of one piece of thin, flexible polymeric material.

### FIELD OF THE INVENTION

The present invention relates to a golf course bunker boundary protection system advantageously formed of a thin polymeric sheet and having a central section located adjacent to the wall of the bunker, lower anchors and upper anchors. The lower anchors are coupled to the central section and located between the sand in the bunker and the soil below the sand. The lower anchors include a means for securing the lower anchors to the soil. The upper anchors are coupled to the central section and located below the grass surrounding the bunker. The upper anchors include a means for attaching the anchors to the grass surrounding the bunker.

### BACKGROUND OF THE INVENTION

Bunkers on golf courses, over time, change shape due to erosion from grass cutting machines and water. Without a protective layer, the edge of the bunker where the grass meets the sand could ultimately creep back five to ten feet over five years. This tends to be a problem because the size of the bunker changes and affects the difficulty of the golf course hole and bunker maintenance. What was once designed to be 100 feet square can easily grow to 150 feet square when the grass around the bunker is trimmed. In some instances, conventional bunkers erode after prolonged periods of water hitting the surface of the bunker. The grass and sod recede in a direction away from the edge of the bunker and grass.

Previous bunker protection systems are known to help keep perimeter grasses from growing into the bunker over time and to help keep contaminated soil from entering the bunker sand. These systems can also resist bunker edge displacement from grass cutting but will eventually be displaced approximately nine months after installation due to the residual effects of water in the bunker. The water causes the system to recede from the edge of the sand and lose its vertical position, thus still changing the shape of the bunker. A previous type of bunker boundary 100 illustrated in FIG. 5 only included a substantially vertical section disposed adjacent the wall of the bunker plus 8 to 12 inch steel nails 101 used at various locations to attach the boundary 100 to the soil. Over time, the bunker boundary 100 would be displaced vertically and horizontally from the water that would eventually enter the bunker. A type of the bunker boundary 100 is sold under the trademark MIGHTY EDGE by Indian Valley Industries—Golf of Johnson City, N.Y.

As seen in FIG. 6, previous bunker boundaries 100 can be used with a flexible, polymeric, porous liner 200 adjacent the bunker boundary 100. The liner 200 abuts the bunker boundary 100 at the end closest to the bunker wall. It can extend along the entire floor of the bunker, or, for example, one-half of the bunker floor, or one-third of the bunker floor, depending upon the desire and need to control sand washouts and sand contamination in the bunker. The liner 200 is retained by stakes 210 that protrude through the liner 200 and into the soil 36. This synthetic liner 200 is designed to grab particles and keep them in place. A type of liner 200 is sold under the trademark SANDTRAPPER by Indian Valley Industries—Golf of Johnson City, N.Y.

Other systems used generally as retaining assemblies in gardens and the like are disclosed in the following: U.S. Pat. No. 4,991,343 to Wait; U.S. Pat. No. 5,212,917 to Kurtz et al.; U.S. Pat. No. 5,640,801 to Rynberk; U.S. Pat. No. 5,857,288 to Wiste; U.S. Pat. No. 6,336,290 to Callan; U.S. Pat. No. 6,568,126 to Womack; U.S. Pat. No. 7,051,477 to Burnham; German Patent Publication No. DE3217953 to Reinhold; and U.S. Patent Application No. 2006/0193703 to Carlson et al.

Accordingly, a need exists for a bunker boundary protection liner that resists the movement of the bunker edge at the junction of the bunker and the grass.

### SUMMARY OF THE INVENTION

Accordingly, an object of the invention is to provide a bunker boundary protection system for preventing the alteration of the bunker's size.

Another object of the invention is to provide a bunker boundary protection system having a central section located adjacent to the wall of the bunker for maintaining the structure of the bunker.

An additional object of the invention is to provide a plurality of lower anchors coupled to the central section, preferably by being integrally formed therewith, and located below the sand in the bunker but above the soil.

A further object of the invention is to provide a means for securing the lower anchors to the soil including apertures in the lower anchors and pins, nails or staples received in the apertures.

Yet another object of the invention is to provide a plurality of upper anchors coupled to the central section, preferably by being integrally formed therewith, and located below the grass surrounding the bunker.

Still another object of the invention is to provide a means for attaching the upper anchors to the grass including apertures to receive the roots of the grass as they grow downwards.

A further object of the invention is to provide a flexible polyethylene sheet for stabilizing the edge of the bunker wherein the sheet is integrally formed as a central vertical section with two horizontal anchor sections, one at each end of the central section.

The foregoing objects are basically attained by providing a bunker boundary protection system having a first section, a second section, and a third section. The first section is central to the second and third sections and is located adjacent to the wall of the bunker. The second section includes a plurality of lower anchors coupled to the first section and located below the sand in the bunker and above the soil in the bunker below the sand. The lower anchors include a plurality of stakes for securing the lower anchors to the soil. The third section includes a plurality of upper anchors coupled to the central section, opposite the second section, and located below the grass surrounding the bunker. The upper anchors include a means for attaching the upper anchors to the grass.

By forming the bunker boundary protection system in this manner, a bunker can retain its initial shape over time without being damaged by rain or trimming the grass. Moreover, the bunker boundary protection system can be retained by its upper and lower anchors, located on opposite sides of the central section. The upper anchors eventually become engaged with roots from a sod composition and the grass because the roots will grow downwards through the apertures in the anchors. The bottom anchors are secured in the soil by a retaining means such as pins, staples, or nails.

As used in this application, the terms “top”, “bottom”, and “side” are intended to facilitate the description of the bunker boundary protection system, and are not intended to limit the description of the bunker boundary protection system to any particular orientation.

Other objects, advantages, and salient features of the present invention will become apparent from the following detailed description, which, taken in conjunction with the annexed drawings, discloses preferred embodiments of the invention.

### BRIEF DESCRIPTION OF THE DRAWINGS

Referring to the drawings which form a part of this disclosure:

FIG. 1 is a side elevational view in vertical cross section of the bunker boundary protection system according to an embodiment of the present invention attached to a bunker with upper and lower anchor means;

FIG. 2 is a top plan view of the bunker boundary protection system seen in FIG. 1 with the upper and lower anchor means extended;

FIG. 3 is a side elevational view in vertical cross section of the bunker boundary protection system seen in FIGS. 1 and 2 with the sand and grass removed for clarity;

FIG. 4 is an exploded side elevational view in vertical cross section of the bunker boundary protection system prior to installation into the ground; and

FIG. 5 is a side elevational view in vertical cross section of a bunker boundary according to the prior art.

Throughout the drawings, like reference numerals will be understood to refer to like parts, components, and structures.

### DETAILED DESCRIPTION OF THE INVENTION

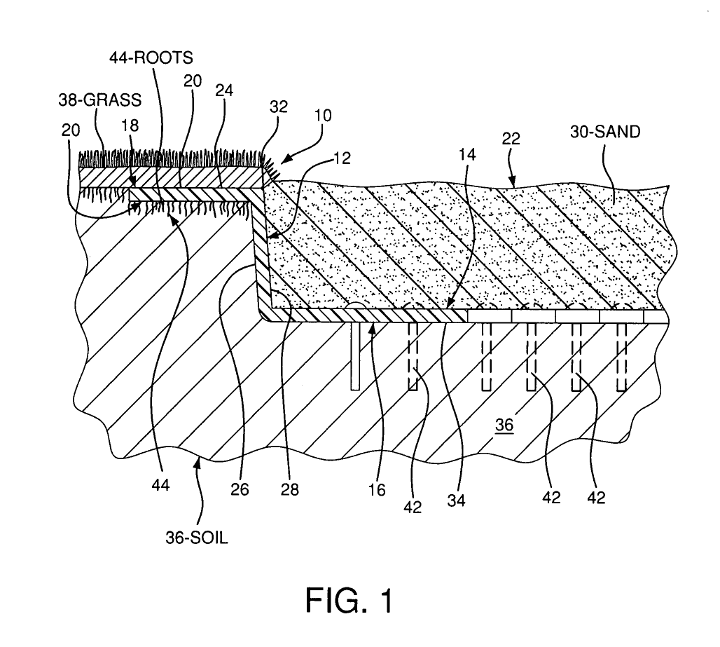

Turning to FIGS. 1-4, a bunker boundary protection system 10 is shown installed into a sand bunker 22 on a golf course for stabilizing and maintaining the structure of the bunker over time. The bunker boundary protection system 10 comprises a central section 12, a lower section 14 having a plurality of lower anchors 16 each coupled to the central section 12, and an upper section 18 having a plurality of upper anchors 20 each coupled to the central section 12. The bunker boundary protection system 10 is placed into a bunker 22 such that the central section 12 is adjacent to the wall 24 of the bunker 22, upper anchors 20 are below the grass 38, and lower anchors 16 are between the sand 30 and soil 36.

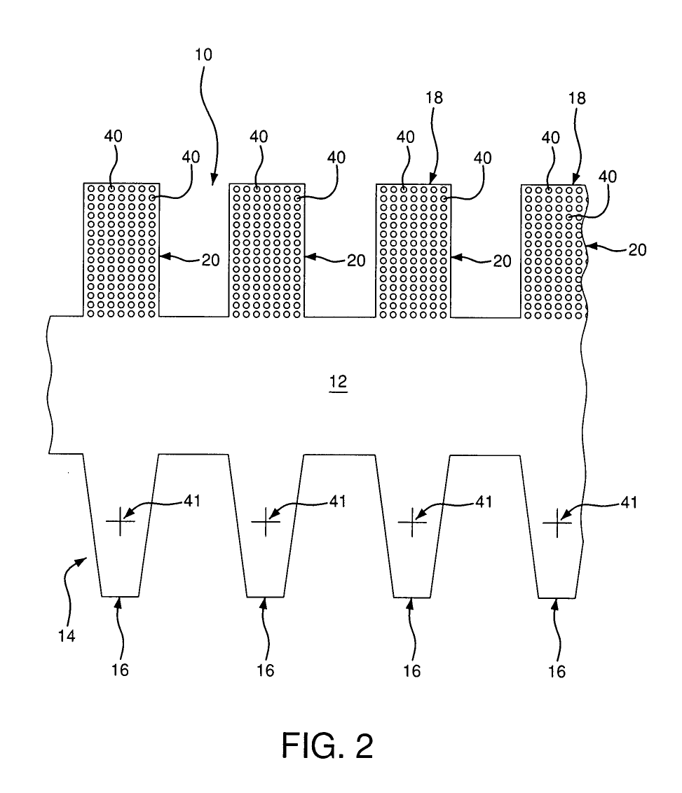

Preferably, the bunker boundary protection system 10 includes the central section 12, upper anchors 20, and lower anchors 16 integrally formed as one piece of material. The material is a sheet of thin, flexible polymeric material, such as linear low polyethylene, preferably 1/16″ thick. Moreover, the material could also be a high density polyethylene. Also, the advantageous dimensions of the central section 12 are 6″×14″, the upper anchors 20 are 6″×2″, and the lower anchors 16 are substantially trapezoidal with a length of 6″ and a width of 2″ adjacent to the central section 12 tapering to a width of 1″ at the furthest point from the central section 12. Manufacture of the system 10 is cheaper and easier by using a sheet of flexible material, and this makes the system stronger and more resistant to water penetration or lateral movement than if the system 10 were made of a plurality of separate parts. As seen in FIGS. 1 and 2, the central section 12 is substantially rectangular having a first side 26 facing the wall 24 of the bunker 22 and a second side 28 facing towards the sand 30 in the interior of the bunker 22. The sand 30 is deposited into the area between the central sections 12 and the lower section 14 to fill the bunker 22.

The central section 12 is defined by a top edge 32 adjacent to the grassy area of the golf course and a bottom edge 34 adjacent to the lowermost part 48 of the bunker 22.

The lower section 14 includes a plurality of lower anchors 16 coupled to and spaced along the bottom edge 34 of the central section 12. Specifically, the lower anchors 16 are adjacent to a floor 46 at a lowermost surface or part 48 of the bunker 22. Each of the lower anchors 16 extends substantially horizontally and substantially perpendicular to the substantially vertical positioning of the central section 12. The lower anchors 16 are located underneath the sand 30 in the bunker 22 and arranged above the soil 36 in the bunker 22. While shown substantially vertical, central section 12 can usually range from about 45° to about 90° or more depending upon the orientation and contour of the bunker wall 24. In addition, while shown substantially horizontal, the lower anchors 16 can usually range from about 10°-15° above or below the horizontal, or even more, depending upon the orientation and contour of the floor 46 of the bunker 22.

As seen in FIG. 2, the lower anchors 16 are substantially trapezoidal in shape and attached to the central section 12 such that the side of the lower anchors 16 with the greatest area is closest to the bottom edge 34. The plurality of lower anchors 16 include a securing means engaging the lower anchors 16 for attaching to the soil 36 inside the bunker 22. Each of the securing means includes at least one opening or aperture 41, preferably precut, for receiving a stake 42 therein which penetrate the soil 36. The stakes 42 can be nails, pins, or staples with enlarged heads or tops.

The upper section 18 includes a plurality of upper anchors 20. Preferably, the upper anchors 20 are substantially rectangularly shaped and coupled to and spaced along the top edge 32 of the central section 12 and adjacent to an uppermost surface 50 of the bunker 22. The upper anchors 20 are located below the grass 38 surrounding the bunker 22. The upper anchors 20 are each positioned substantially horizontally and substantially perpendicularly to the vertical positioning of the central section 12, although the upper anchors 20 can usually range from about 10°-15° above or below the horizontal, or even more, depending upon the orientation and contour of the soil and grass surrounding the bunker 22. The upper anchors 20 are spaced apart from each other approximately the same distance as the width of each of the upper anchors 20.

The upper anchors 20 include a means for attaching the upper anchors 20 to the soil or ground surrounding the bunker 22. A grass sod composition is placed atop the upper anchors 20 for anchoring to the surface. Each of the upper anchors 20 includes a plurality of apertures 40 disposed beneath the sod composition comprising part of an attachment means for anchoring the anchors 20 to the ground. The means for attaching the upper section 18 into the ground includes the plurality of apertures 40 and a plurality of roots 44 received therein. The roots 44 from the grass sod composition grow downwardly through the anchor apertures 40 to further secure the upper anchors 20 to the ground. Alternately, the upper section can be permanently or temporarily attached to the soil below the sod via stakes, such as pins, nails or staples.

In this manner, when the grass is cut from the sod composition at the top or the sides, the shape of the bunker 22 will remain the same because the horizontal positioning of the upper anchors 20 with respect to the central section 12 and the central section 12 itself will be restrained by the force of the roots 44, the central section 12 being engaged by the wall 24, and the lower anchors 16 being staked to the soil 36. Essentially, the web intertwining the roots 44 and the apertures 40 provides a netting to trap the upper anchors 20 and restrict lateral movement.

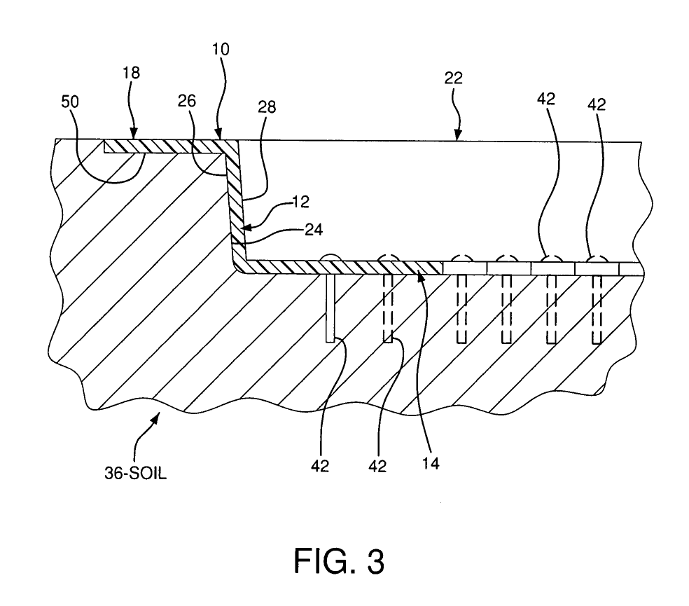

As seen in FIG. 3, when the bunker boundary protection system 10 is initially installed in the bunker 22, grass has not yet grown through the upper anchors 20. The lower section 14 is retained by the plurality of stakes 42 received through the sheet adjacent to a floor 36 at the lowermost surface of the bunker 22. Once grass is placed over the upper section 18 and the roots 44 are stabilized in the soil 36 and apertures 40, the upper anchors 40 will be restrained into the ground surface as seen in FIG. 1.

Optionally, the bunker boundary protection system 10 could be used in conjunction with the liner 200 illustrated in FIG. 6. The liner 200 would be positioned on top of the lower anchors 16 before sand 30 is added to the bunker 22.

### Installation

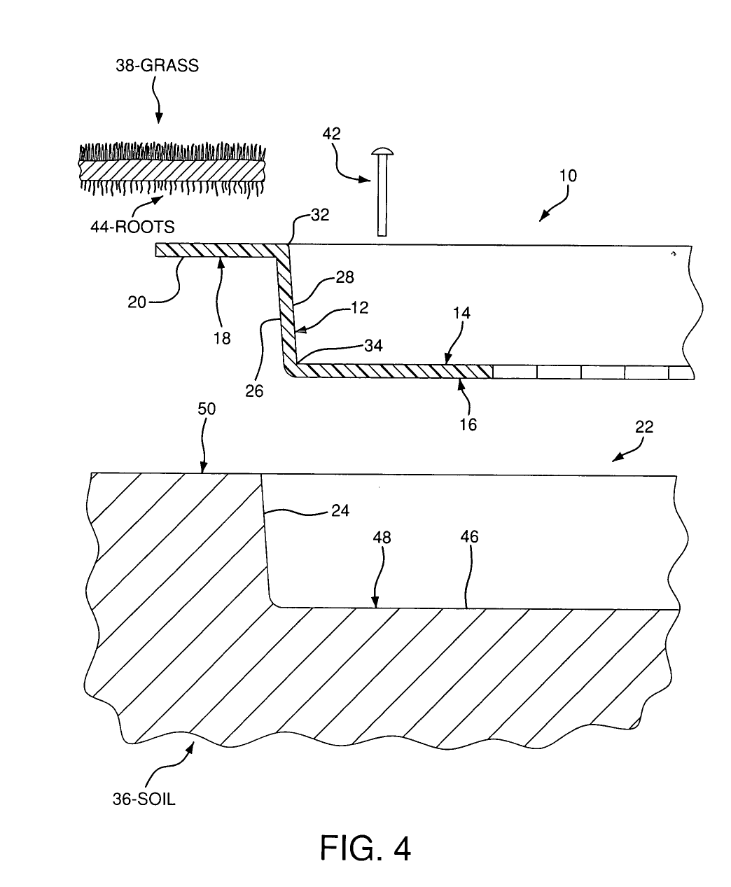

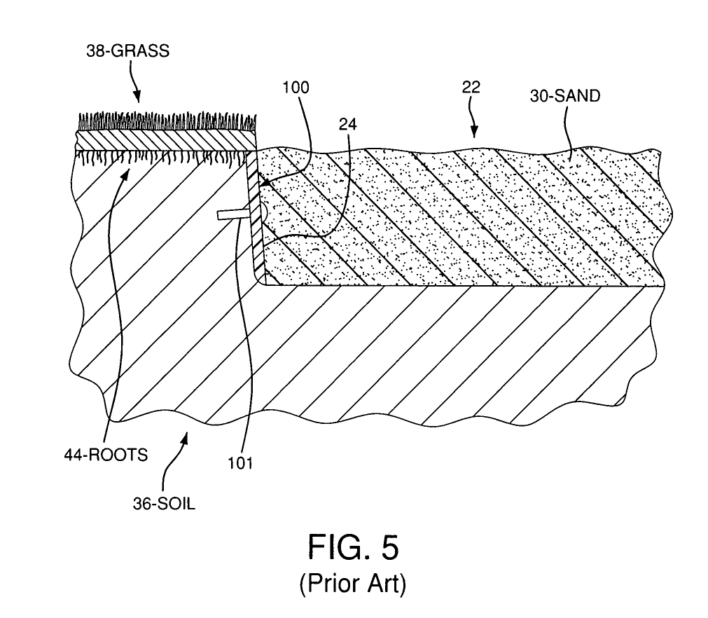

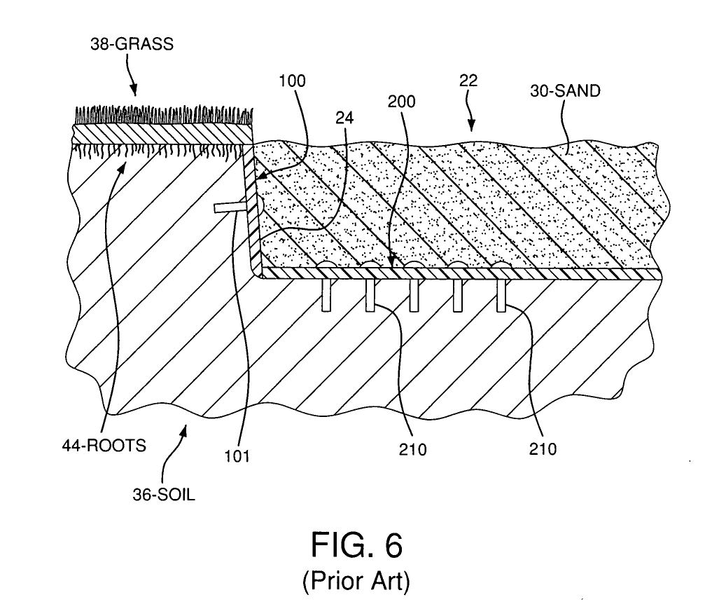

Referring to FIGS. 3 and 4, the bunker boundary protection system 10 is placed into the bunker 22 with the central section 12 adjacent to an upper wall with its first side 26 adjacent to the bunker wall 24. Likewise, the lower section 14 is placed on top of the soil 36 and the upper section 18 is placed atop the uppermost surface 50 of the bunker 22. The lower anchors 16 will be arranged adjacent to the floor 46 at the lowermost surface or part 48 of the bunker. Each of the lower anchors 16 will extend substantially horizontally and substantially perpendicular to the substantially vertical positioning of the central section 12.

The upper anchors 20 will each be positioned substantially horizontally and substantially perpendicularly to the vertical positioning of the central section 12. To restrain the lower section 14, a plurality of stakes 42 are placed into the at least one opening or aperture 41 of the lower anchors 16 and penetrate the soil 36. The stake 42 can be a nail, pin, or staple with an enlarged head.

The upper section 18 is restrained by placing sod above the plurality of upper anchors 20. The upper anchors 20 are coupled to and spaced along the top edge 32 of the central section 12 and adjacent to the uppermost surface 50 of the bunker 22. The upper anchors 20 will be located below the grass 38 surrounding the bunker 22, as seen in FIG. 1, and spaced apart from each other approximately the same distance as the width of each of the upper anchors 20.

If desired, the liner 200 is placed directly on top of the lower anchors 16. Once positioned, sand 30 will be filled into the bunker 22 such that the lower anchors 16 will be located underneath the sand 30 in the bunker 22 and arranged above the soil 36 in the bunker 22. Over time, the upper anchors 20 will eventually become engaged with roots 44 from the sod composition and the grass 38 because the roots 44 will grow downwards through the apertures 40 in the anchors 20.

While a particular embodiment has been chosen to illustrate the invention, it will be understood by those skilled in the art that various changes and modifications can be made therein without departing from the scope of the invention as defined in the appended claims.

What is claimed is:

1. A bunker boundary protection system comprising:
a central section located adjacent the wall of a bunker;
a plurality of lower anchors coupled to said central section and located below the sand in the bunker and above the soil in the bunker below the sand, said lower anchors comprising means for securing said lower anchors to the soil; and
a plurality of upper anchors coupled to said central section and located below the grass surrounding the bunker, said upper anchors comprising means for attaching said upper anchors to the grass.

2. A bunker boundary protection system according to claim 1, wherein
said means for securing said lower anchors includes a plurality of apertures.

3. A bunker boundary protection system according to claim 1, wherein
said central section, upper anchors and lower anchors are comprised of one sheet of flexible polyethylene.

4. A bunker boundary protection system according to claim 1, wherein
said means for securing said lower anchors to the soil comprises a plurality of stakes.

5. A bunker boundary protection system according to claim 1, wherein
said means for attaching said upper anchors to the grass comprises a plurality of apertures.

6. A bunker boundary protection system disposed on a wall of the bunker, the bunker having soil at the bottom and sand on the soil, and grass substantially surrounding the bunker wall, said protection system comprising:
a central section located adjacent the wall of the bunker;
a plurality of lower anchors coupled to said central section and located below the sand in the bunker and above the soil in the bunker below the sand, said lower anchors comprising means for securing said lower anchors to the soil; and
a plurality of upper anchors coupled to said central section and located below the grass substantially surrounding the bunker, said upper anchors comprising means for attaching said lower anchors to the grass.

7. A golf course boundary protection system according to claim 6, wherein
said means for securing is a plurality of stakes.

8. A golf course boundary protection system according to claim 6, wherein
said lower anchors are adjacent to a floor at a lowermost surface of said bunker.

9. A golf course boundary protection system according to claim 6, wherein
said upper anchors are adjacent to an uppermost surface of said bunker.

10. A bunker boundary protection system according to claim 6, wherein
said upper anchors include a plurality of apertures disposed beneath the grass for receiving downwardly-growing roots of the grass.

11. A bunker boundary protection system according to claim 6, wherein
said central section, upper anchors, and lower anchors are comprised of one sheet of flexible polymeric material.

12. A bunker boundary protection system according to claim 6, wherein
said upper anchors are spaced from one another along said central section.

13. A bunker boundary protection system according to claim 6, wherein
said plurality of lower anchors comprise at least one opening and a stake received therein.

14. A bunker boundary protection system according to claim 6, wherein
said lower anchors are spaced from one another along said central section.

15. A bunker boundary protection system according to claim 14, wherein
said upper anchors are spaced from one another along said central section.

16. An apparatus for protecting the boundary of a golf course bunker comprising:
a central section having a top and a bottom;
a plurality of upper anchors attached to said top, each of said upper anchors having means for securing said upper anchors to the soil surrounding the bunker; and
a plurality of lower anchors attached to said bottom, each of said lower anchors having means for attaching said lower anchors to the soil inside the bunker.

17. An apparatus according to claim 16, wherein
said central section, upper anchors, and lower anchors are integrally formed as one-piece of flexible material.

18. An apparatus according to claim 17, wherein
said one-piece of material is thin, flexible polymeric material.

19. An apparatus according to claim 16, wherein
said central section is substantially rectangular.

20. An apparatus according to claim 16, wherein
said means for securing comprises a first set of a plurality of apertures, and said means for attaching comprises a second set of a plurality of apertures.

21. An apparatus according to claim 20, wherein
said means for attaching further comprises a plurality of stakes.

22. An apparatus according to claim 21, wherein
said stakes comprise a plurality of nails, pins, or staples.

23. A method of installing a golf course bunker boundary protection system in a bunker comprising the steps of
positioning a central section of the system adjacent the side wall of the bunker,
positioning a plurality of lower anchors coupled to the central section adjacent the soil in the bottom of the bunker,
securing the lower anchors to the soil in the bottom of the bunker,
positioning a plurality of upper anchors coupled to said central section adjacent the soil adjacent the side wall of the bunker,
positioning grass sod on the plurality of upper anchors, and
introducing sand into the bunker to substantially cover the central section and lower anchors.

24. A method according to claim 23, wherein
the upper anchors have a plurality of apertures therein for receiving roots of the grass sod upon downward movement and/or growth of the roots.

25. A method according to claim 23, wherein
the step of securing the lower anchors to the soil comprises inserting stakes through the lower anchors and into the soil.

26. A method according to claim 23, wherein
the central section, lower anchors and upper anchors are preformed in one piece of a thin flexible sheet.

27. A method according to claim 26, wherein
the thin flexible sheet is made of polymeric material.
